(19) United States
(12) Patent Application Publication
(10) Pub. No.: US 2018/0018350 A1
(43) Pub. Date: Jan. 18, 2018

(54) USER-FRIENDLY SYSTEM AND METHOD TO FIND LOST SENTIMENTAL ITEMS

(71) Applicant: Joni Taylor, Montgomery, TX (US)

(72) Inventor: Joni Taylor, Montgomery, TX (US)

(21) Appl. No.: 15/211,015

(22) Filed: Jul. 15, 2016

(51) Int. Cl. G06F 17/30; H04N 1/00; H04L 12/58; G06K 9/62; G06F 3/0484; H04N 5/225; G06F 3/0482

(52) U.S. Cl. CPC G06F 17/30259; H04N 5/2252; H04N 1/00204; G06F 3/0482; G06K 9/6201; G06F 3/0484; H04L 51/32

(57) ABSTRACT

A method for finding the lost item or the rightful owner of the found item over the network is provided. The method includes the following steps: (i) images of the lost item are uploaded by the first user to the database to find the lost item, (ii) the images of the found item are uploaded by the second user to the database, (iii) the lost item is searched in the database to find a match for the lost item, (iv) a list of lost and found items related to the lost item is displayed, (v) the lost item is compared with the list of lost and found items to find the lost item, (vi) the second user of the match for the lost item is identified when the match is found, and (vii) the first user communicated with the second user to regain possession of the lost item.

### TECHNICAL FIELD

The embodiments herein generally relate to a lost-and-found system, and, more particularly, to a user-friendly system that connects people who have lost sentimental items with those who have found them.

### DESCRIPTION OF THE RELATED ART

People love to keep cherished memories alive. Most of the times, it is the sentimental items associated with one's personal moments which make up the memories. Unfortunately, people tend to lose things they love the most and normally, it becomes very hard for them to survive the loss of such items. One of the possibilities is that the lost item is ultimately found by a familiar person or a stranger but then, the founder cannot possibly know who the rightful owner of the lost item is.

The need is to fill gap between the owner and the founder. This is best done electronically such as through a social network where owner/founder shares information regarding lost/found items and thus communication aids the owner to regain possession of the lost item. Similar systems for things such as lost cell phones, lost pets, etc are already known but none give solution specifically for finding lost sentimental items.

Accordingly, there remains a need for an effective lost-and-found system that helps the owners to find back their lost sentimental items.

### SUMMARY

In view of the foregoing embodiment herein provides a lost-and-found system that allows one or more users to find a lost item or a rightful owner of a found item, over a network. The lost-and-found system includes a memory unit, a processor and a display unit. The memory unit stores a database, and one or more modules. The processor processes the one or more modules. The one or more modules include a lost item image uploading module, a found item image capturing and uploading module, a searching module, and a chatting module. The lost item image uploading module is configured to allow a first user from the one or more users to upload latest images of the lost item to the database. The found item image capturing and uploading module is configured to allow a second user from the one or more users to capture one or more images of the found item and upload the one or more images to the database. The searching module is configured to allow (i) the first user to search for the lost item, and (ii) the second user to search for the found item, from the database. The chatting module is configured to allow the first user and the second user to send or receive one or more messages. The display unit is configured to display (i) one or more images of the lost item, (ii) one or more images of the found item, and (iii) the messages, on a user computing device.

In another aspect, a method for finding the lost item or the rightful owner of the found item over the network is provided. The method includes the following steps: (i) one or more images of the lost item are uploaded by the first user to the database to find the lost item, (ii) the one or more images of the found item are uploaded by the second user to the database, (iii) the lost item is searched in the database to find a match for the lost item, (iv) a list of lost and found items related to the lost item is displayed, (v) the lost item is compared with the list of lost and found items to find the lost item, (vi) the second user of the match for the lost item is identified when the match is found, and (vii) the first user communicated with the second user to regain possession of the lost item.

These and other aspects of the embodiments herein will be better appreciated and understood when considered in conjunction with the following description and the accompanying drawings. It should be understood, however, that the following descriptions, while indicating preferred embodiments and numerous specific details thereof are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a lost-and-found system implemented in a user computing device that interacts with a server to find one or more lost sentimental items according to an embodiment herein;

FIG. 2 illustrates an exploded view of the lost-and-found system of FIG. 1 according to an embodiment herein;

FIG. 3A illustrates a user interface view of the lost-and-found system of FIG. 1 for interacting with the lost-and-found system according to an embodiment herein;

FIGS. 3B-3D illustrates user interface views of the lost-and-found system according to an embodiment herein;

FIG. 4 is a flow diagram illustrating a method for finding the lost item or the rightful owner of the found item over the network according to an embodiment herein;

FIG. 5 illustrates an exploded view of the computing device of FIG. 1 according to an embodiments herein; and

FIG. 6 illustrates a schematic diagram of computer architecture used in accordance with an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

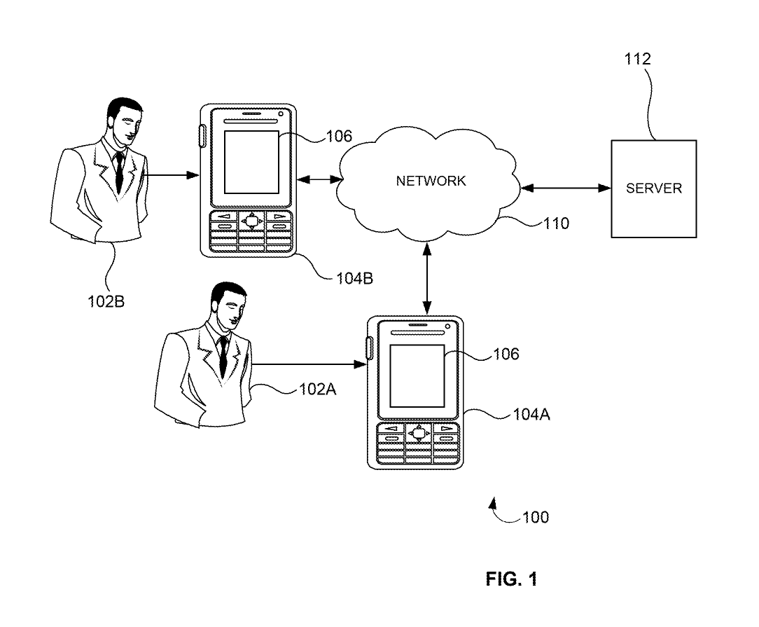

As mentioned, there remains a need for a system and method that helps the owners to find the lost sentimental items and regain possession. The embodiments herein achieve this by providing a lost-and-found system. Referring now to the drawings, and more particularly to FIGS. 1 through 6, where similar reference characters denote corresponding features consistently throughout the figures, there are shown preferred embodiments.

FIG. 1 illustrates a system view 100 of a lost-and-found system 106 implemented in a user computing device that interacts with a server 112 to find one or more lost sentimental items according to an embodiment herein. The lost-and-found system 106 manages uploading and retrieving of information about the one or more lost sentimental items and create a social network, thus providing an aid in finding the one or more lost sentimental items through a user's communication. The system view 100 includes a first user 102A, a second user 102B, a first user computing device 104A, a second user computing device 104B, the lost-and-found system 106, a network 110, and the server 112. The lost-and-found system 106 can be implemented in the first user computing device 104A that interacts with the server 112 through the network 110 to upload one or more images and/or information about the one or more lost sentimental items into a database, and to search for the one or more lost sentimental items from a list of sentimental items found and/or uploaded by one or more second users. In one embodiment, the first user 102A is a person who lost the one or more sentimental items. In one embodiment, the first user computing device 104A and the second user computing device 104B is (i) a mobile phone, (ii) a computer, and/or (iii) a laptop.

The lost-and-found system 106 can be implemented in the second user computing device 104B that interacts with the server 112 through the network 110 to capture and upload one or more images and/or information of one or more found sentimental items into the database and to search for a match from a list of sentimental items lost and/or uploaded by the first user 102A. In one embodiment, the second user 102B is a person who found the one or more sentimental items. In another embodiment, the lost-and-found system 106 may be implemented in a remote server and the network 110 may be an internet or a broadcast network.

The first user computing device 104A and the second user computing device 104B provides input data to the lost-and found system 106. The input data is selected from a group including of (i) one or more images of the one or more sentimental items, (ii) information describing the one or more sentimental items, (iii) information describing circumstances in which the one or more sentimental item was lost or found, (iv) information describing how the lost item can be found, and (v) information regarding how prospective owners can regain possession of the sentimental items. Examples of the sentimental items include but are not limited to a photo album, a family bible, an old box of Grandma's secret recipes, an old watch gifted by Grandpa, etc.

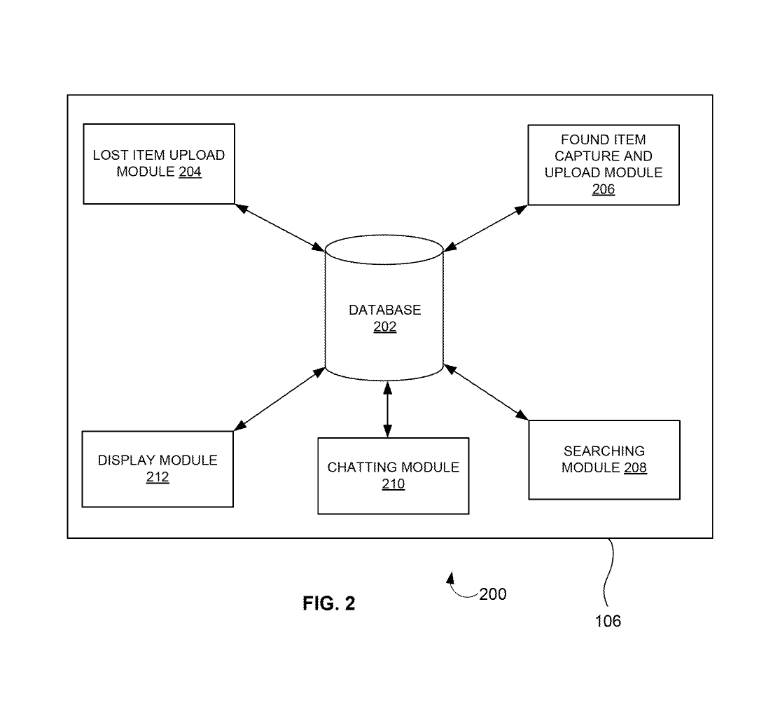

FIG. 2 illustrates an exploded view 200 of the lost-and-found system 106 of FIG. 1 according to an embodiment herein. The exploded view 200 includes a database 202, a lost item upload module 204, a found item capture and upload module 206, a searching module 208, a chatting module 210, and a display module 212. The database 202 stores images of the one or more sentimental items and information relating to the one or more sentimental items. The lost item upload module 204 is configured to allow the first user 102A to upload either (i) one or more previously captured images of the one or more lost sentimental items, and/or (ii) information about the one or more lost sentimental items such as appearance, color, shape, details about where and how the sentimental item(s) were lost, etc. The one or more previously captured images and/or information about the one or more lost sentimental items are stored in the database 202.

The found item capture and upload module 206 is configured to allow the second user 102B to capture one or more images of one or more found sentimental items and upload (i) the one or more captured images of the one or more found sentimental items, and (ii) information describing the one or more found sentimental items such as appearance, shape, color, details about the time and place where the sentimental item(s) was/were found. The first user computing device 104A and the second user computing device 104B are equipped with a camera to the one or more images of the one or more sentimental items. In one embodiment, (i) a mobile phone, (ii) a computer, (iii) a laptop, or/and (iv) any other camera equipped device with a feature of transferring the imaged captured are used to transfers the one or more images to the first user computing device 104A and the second user computing device 104B. The one or more images and/or information about the one or more found sentimental items are stored in the database 202.

The searching module 208 is configured to allow the first user 102A and the second user 102B to search for one or more sentimental items using a set of keywords and/or phrases. When a search is made by the first user 102A, a list of related sentimental items found by one or more other users is displayed on the first user computing device 104A. The first user 102A is then allowed to scroll down the list of found sentimental items to find a post showing a matching sentimental item. If a matching item is found from the list, the first user 102A can claim the item by leaving a message to the second user 102B who posted the found item.

When a search is made by the second user 102B, a list of related sentimental items lost by one or more other users is displayed on the second user computing device 104B. The second user 102B is then allowed to scroll down the list of lost sentimental items to find a post showing a matching sentimental item. If a matching item is found from the list, the second user 102B may leave a message to the first user 102A informing about the found sentimental item or asking the user to confirm about the ownership of the sentimental item. In one embodiment, the searching module 208 is configured to search for the one or more sentimental items using the one or more images instead of keywords or phrases.

The chatting module 210 is configured to allow the first user 102A to communicate with the second user 102B and vice-versa. In one embodiment, the first user 102A may send/receive a message to/from the second user 102B and vice-versa. The communication between the first user 102A and the second user 102B is either a one-way or a two-way communication. In one embodiment, features such as group messaging are also included. The messages are, but are not limited to, (i) a text message, (ii) a picture message, (iii) an audio message, and (iv) a video message. The display module 212 is configured to display a user interface of the lost-and-found system 106. In one embodiment, the user interface includes (i) the one or more images of the one or more sentimental items.

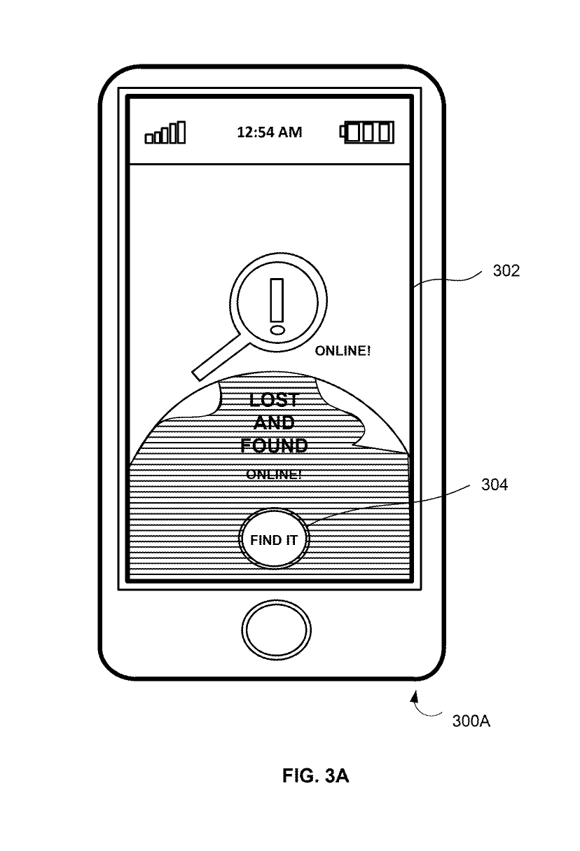

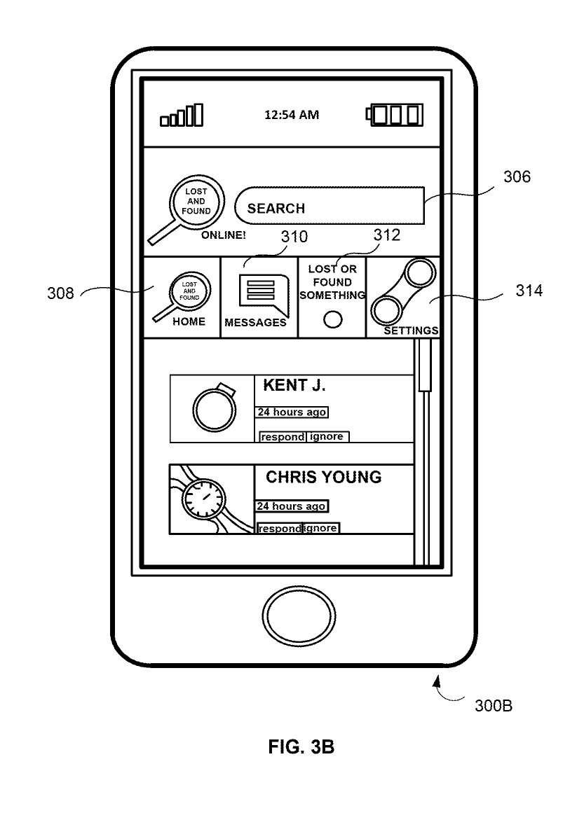

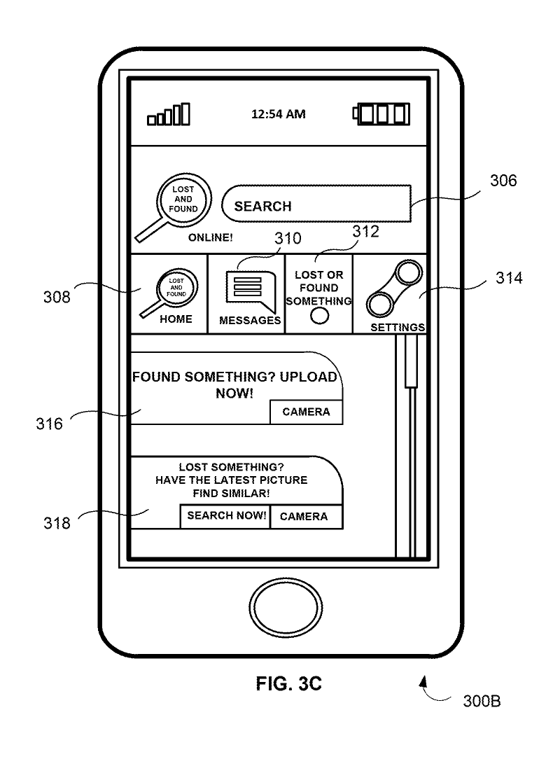

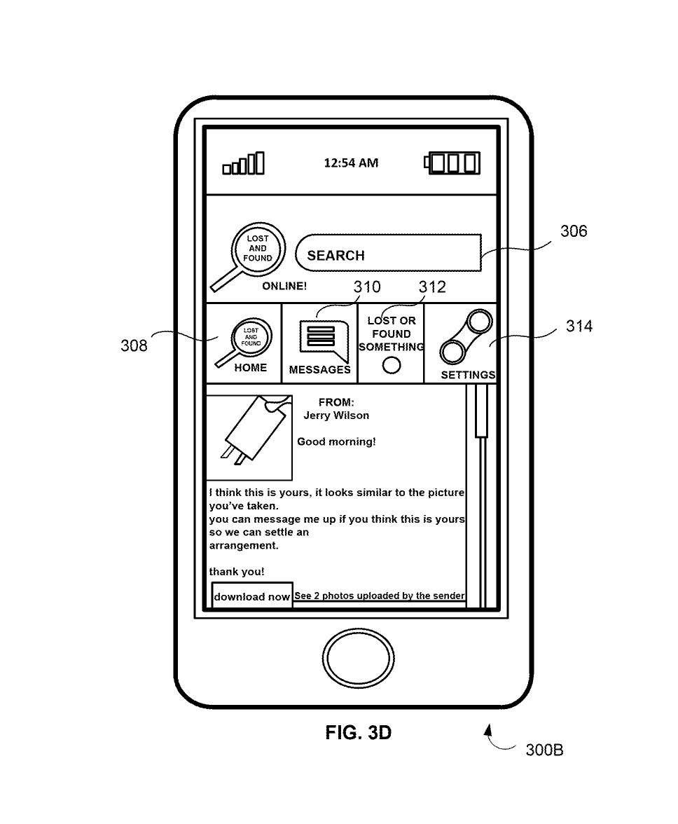

FIG. 3A illustrates a user interface view 300A of the lost-and-found system 106 of FIG. 1 for interacting with the lost-and-found system 106 according to an embodiment herein. When the first user 102A or the second user 102B logs into the lost-and-found system 106, a home page 302 of the lost-and-found system 106 is displayed on the user first computing device 104A or the second computing device 104B as shown in FIG. 3A. The home page 302 includes a FIND IT button 304 at the bottom. When the first user 102A presses the find it button 304, the first user 102A is redirected to the next page of the lost-and-found system 106.

FIGS. 3B-3D illustrates user interface views 300B of the lost-and-found system 106 according to an embodiment herein. The user interface view 300B include a search tab 306, a home tab 308, a messages tab 310, a lost or found something tab 312, a settings tab 314, a found tab 316, and a similar 318. A search may be made by the first user 102A as well as the second user 102B on the search tab 306 of the user interface view 300. The search tab 306 allows the first user 102A or the second user 102B to search for one or more sentimental items using a set of keywords and/or phrases. Using an appropriate search strategy, the first user 102A may find a list of related sentimental items. In one embodiment, the list is displayed on the display of the first user computing device 104A in a space just below the tabs available as shown in FIG. 3B. The first user 102A is allowed to scroll down the list to locate the matching sentimental item(s). In another embodiment, the search is made using related image(s) instead of keywords/phrases under the search tab 306.

The home tab 308 is configured to take the first user 102A back to the home page 302. The messages tab 310 displays conversations of the first user 102A with the second user 102B. The messages tab 310 is configured to send a new message to another user or start a new conversation. Any message received from the other users is also displayed in the messages tab 310. A scroll bar is also provided adjacent to the messages to allow the user to scroll down the list of messages in the inbox according to an embodiment herein. The lost or found something tab 312 is configured to take the user to a new page wherein the flexibility of the user interface view 300 poses two new tabs, one to be used by the first user 102A, and the other to be used by the second user 102B as shown in FIG. 3C. The found tab 316 allows the second user 102B to capture and upload the one or more images of the one or more found sentimental items. In one embodiment, a camera button adjacent to the found tab 316 is provided to the one or more image using the camera. After capturing the one or more images of the one or more found sentimental item(s), the second user 102B is allowed to upload the image(s) along with the detailed information into the database 202.

The similar tab 318 is configured to allow the first user 102A to either (i) upload the latest picture of the one or more lost sentimental items, or (ii) if in case the latest picture is not available, search for the one or more lost sentimental items using keywords. In one embodiment, two separate buttons are provided adjacent to the similar tab 318, one button for uploading the latest picture and the other button for skipping the uploading function and start searching the one or more lost sentimental items directly. A search now button is clicked by the first user 102A to start searching for the one or more lost sentimental items directly.

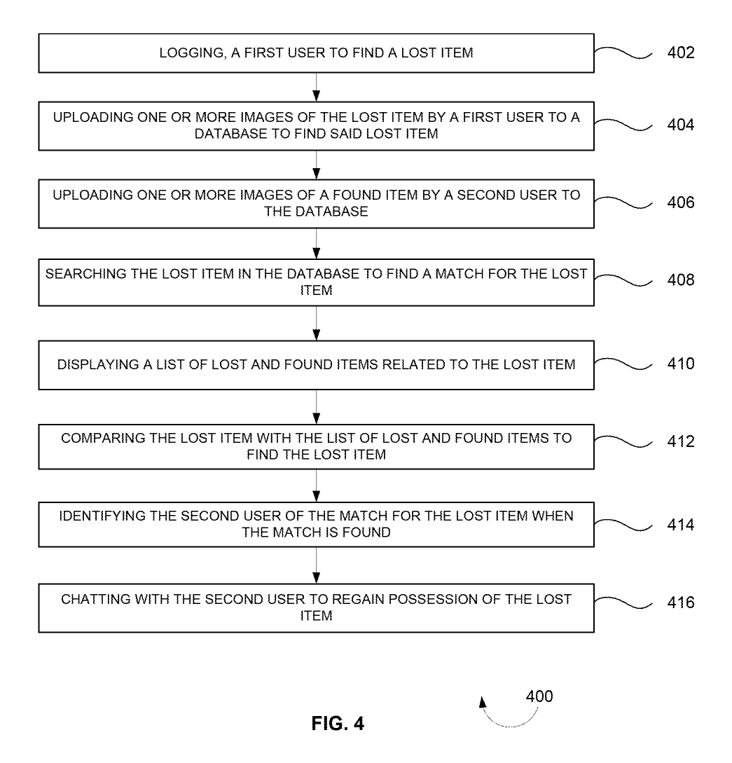

FIG. 4 is a flow diagram 400 illustrating a method for finding the lost item or the rightful owner of the found item over the network 110 according to an embodiment herein. The method includes the following steps: (i) the one or more images of the lost item are uploaded by the first user 102A to the database 202 to find the lost item, (ii) the one or more images of the found item are uploaded by the second user 102B to the database 202, the lost item is searched in the database 202 to find a match for the lost item, (iv) a list of lost and found items related to the lost item is displayed, (v) the lost item is compared with the list of lost and found items to find the lost item, (vi) the second user 102B of the match for the lost item is identified when the match is found, and (vii) the first user 102A is communicated with the second user 102B to regain possession of the lost item.

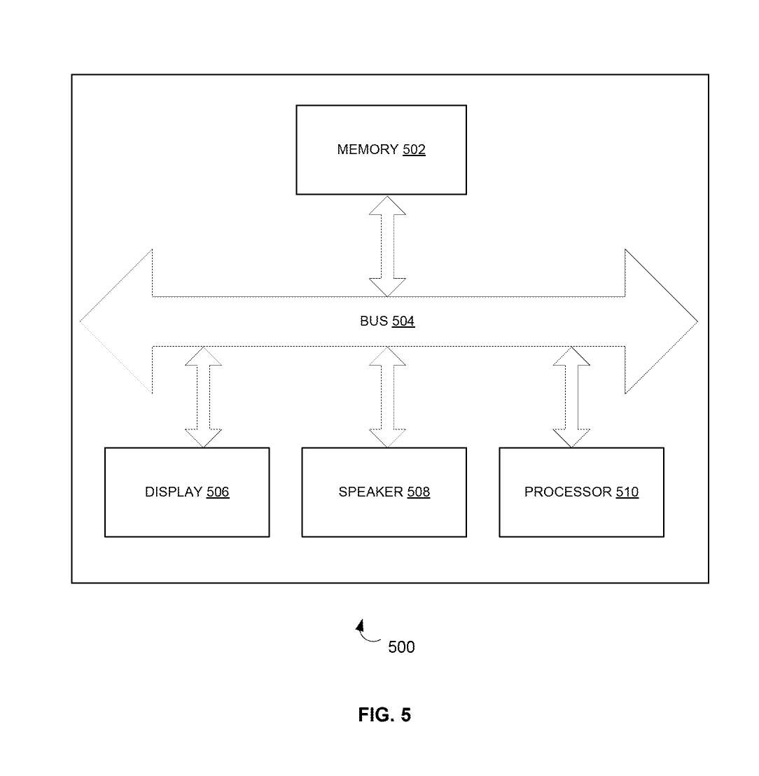

FIG. 5 illustrates an exploded view of the computing device having a memory 502 having a set of computer instructions, a bus 504, a display 506, a speaker 508, and a processor 510 capable of processing a set of instructions to perform any one or more of the methodologies herein, according to an embodiment herein. In one embodiment, the receiver may be the computing device. The processor 510 may also enable digital content to be consumed in the form of video for output via one or more displays 506 or audio for output via speaker and/or earphones 508. The processor 510 may also carry out the methods described herein and in accordance with the embodiments herein.

Digital content may also be stored in the memory 502 for future processing or consumption. The memory 502 may also store program specific information and/or service information (PSI/SI), including information about digital content (e.g., the detected information bits) available in the future or stored from the past. A user of the personal communication device may view this stored information on display 506 and select an item of for viewing, listening, or other uses via input, which may take the form of keypad, scroll, or other input device(s) or combinations thereof. When digital content is selected, the processor 510 may pass information. The content and PSI/SI may be passed among functions within the personal communication device using the bus 504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

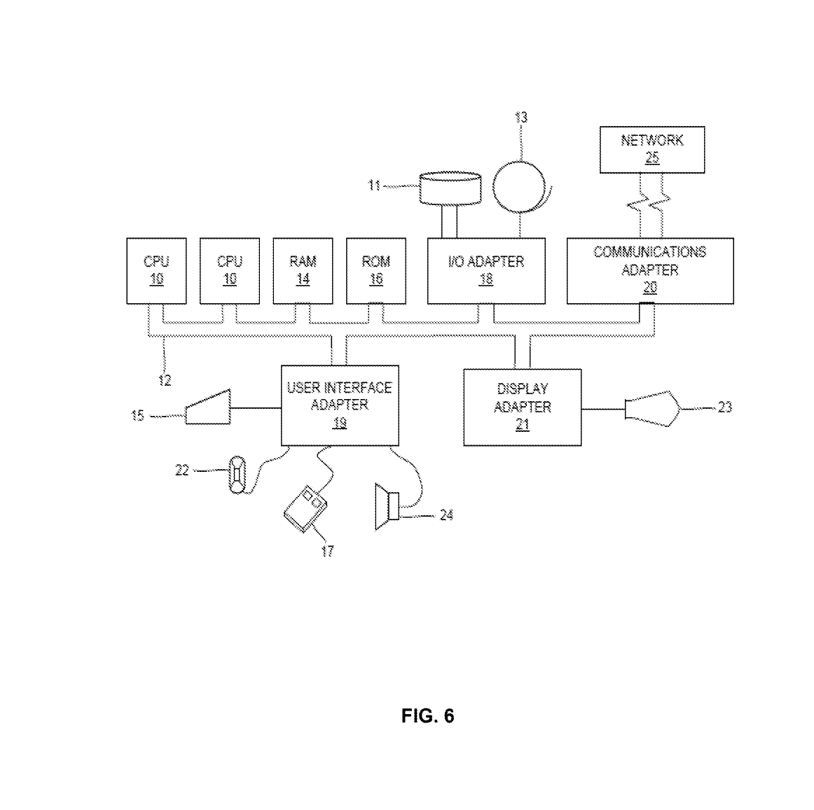

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The lost-and-found system 106 is different from what is available in the market in respect that the said system is preferentially based for the people who have lost not just mere items but sentimental items, for example, items lost during change of residence, natural calamity, etc. Through such system, the user gets a hope to pursue searching for the lost sentimental item(s) which otherwise would have lost in a second of time. In absence of said lost-and-found system 106, a person who finds a sentimental item lost by another person will have no idea what to do with that item or where to look for the rightful owner of the sentimental item. An advantage of the lost-and-found system 106 is that a social network is created among the users where strangers, or even long lost neighbors, friends, or relatives may connect with each other on the grounds of lost-and-found memories. The lost-and-found system 106 gives the user the ability to upload pictures, describe items, give a back story to the item, or maybe describe the circumstance of how the item was lost or found or how it could be found. Apart from being applicable in case of sentimental items, the lost-and-found system 106 may also be used for usual items such as cell phones, pets, car keys, etc. Also the lost-and-found system 106 benefits by cutting down much of the efforts of the user to find the lost sentimental item(s).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A lost-and-found system that allows a plurality of users to find a lost item or a rightful owner of a found item, over a network, wherein said system comprises:
a memory unit that stores a database, and a plurality of modules;
a processor that processes said plurality of modules, wherein said plurality of modules comprises:
a lost item image uploading module, executed by said processor, that is configured to allow a first user from the said plurality of users to upload a plurality of latest images of said lost item to said database;
a found item image capturing and uploading module, executed by said processor, that is configured to allow a second user from the said plurality of users to capture a plurality of images of said found item and upload the said plurality of images to the said database;
a searching module, executed by said processor, that is configured to allow (i) said first user to search for the said lost item, and (ii) said second user to search for the said found item, from the said database; and
a chatting module, executed by said processor, that is configured to allow said first user and said second user to send or receive messages; and
a display unit that is configured to display (i) a plurality of images of said lost item, (ii) a plurality of images of said found item, and (iii) said messages on a user computing device.

2. The lost-and-found system of claim 1, wherein said lost item is a sentimental item.

3. The lost-and-found system of claim 1, wherein said network is a wireless communication network.

4. The lost-and-found system of claim 1, wherein said lost-and-found system is implemented in said user computing device.

5. The lost-and-found system of claim 1, wherein said found item capturing and uploading module is further configured to capture said plurality of images using a camera unit integrated in said user computing device.

6. The lost-and-found system of claim 1, wherein said messages are text messages, picture messages, audio messages, or video messages.

7. The lost-and-found system of claim 1, wherein said display unit is integrated in said user computing device.

8. The lost-and-found system of claim 6, wherein said user computing device is a mobile phone, a computer, or a laptop.

9. A method for finding a lost item or a rightful owner of a found item over a network, wherein said method comprises:
uploading a plurality of images of a lost item by a first user to a database to find said lost item;
uploading a plurality of images of a found item by a second user to said database;
searching said lost item in said database to find a match for said lost item;
displaying a list of lost and found items related to said lost item;
comparing said lost item with said list of lost and found items to find said lost item;
identifying said second user of said match for said lost item when said match is found;
chatting with said second user to regain possession of said lost item.

10. The method of claim 10, wherein said method comprises:
capturing said plurality of images of said found item by said second user using a camera unit integrated in a user computing device.

11. The method of claim 10, wherein said searching of said lost item is performed using (i) keywords, (ii) phrases, or (iii) images.

12. A non-transitory program storage device readable medium by a computer, and comprising a program of instruction executable by said computer to perform a method for finding a lost item or a rightful owner of a found item over a network, wherein said method comprises:
uploading a plurality of images of a lost item by a first user to a database to find said lost item;
uploading a plurality of images of a found item by a second user to said database;
searching said lost item in said database to find a match for said lost item;
displaying a list of lost and found items related to said lost item;
comparing said lost item with said list of lost and found items to find said lost item;
identifying said second user of said match for said lost item when said match is found;
chatting with said second user to regain possession of said lost item.

13. The non-transitory machine-readable medium of claim 12, wherein said method comprises:
capturing said plurality of images of said found item by said second user using a camera unit integrated in a user computing device.

14. The non-transitory machine-readable medium of claim 12, wherein said searching of said lost item is performed using (i) keywords, (ii) phrases, or (iii) images.
